(19) United States
(12) Patent Application Publication
(10) Pub. No.: US 2018/0371717 A1
(43) Pub. Date: Dec. 27, 2018

(54) Integral Precast Foundation Base for Pumping Unit

(71) Applicant: Lufkin Industries, LLC, Lufkin, TX (US)

(72) Inventor: Robert Miler Jones, Diboll, TX (US)

(73) Assignee: Lufkin Industries, LLC, Lufkin, TX (US)

(21) Appl. No.: 16/019,357

(22) Filed: Jun. 26, 2018

Related U.S. Application Data
(60) Provisional application No. 62/525,061, filed on Jun. 26, 2017.

(51) Int. Cl. E02D 27/44; E21B 43/12; F16M 5/00; F04B 47/02

(52) U.S. Cl. CPC E02D 27/44; E21B 43/127; F16M 5/00; F04B 47/022; E02D 2600/20; E02D 2250/0046; E02D 2300/0034; E02D 2300/002; E02D 2200/1642

(57) ABSTRACT

A beam pumping unit includes an integrated base assembly that has a precast concrete pad and a support base partially embedded within the precast concrete pad. The beam pumping unit further includes a pedestal supported by the support base and a Samson post supported by the support base. Also disclosed is a method for making and assembling a beam pumping unit near a wellhead. The method includes the steps of producing an integrated base assembly that has a support base within a concrete pad, placing the integrated base assembly near the wellhead, and securing a Samson post to the integrated base assembly.

### RELATED APPLICATIONS

This application claims the benefit of U.S. Provisional Patent Application Ser. No. 62/525,061 filed Jun. 26, 2017 entitled “Integral Precast Foundation Base for Pumping Unit,” the disclosure of which is herein incorporated by reference.

### FIELD OF THE INVENTION

This invention relates generally to oilfield equipment, and more particularly, but not by way of limitation, to an improved base system for supporting a beam pumping unit.

### BACKGROUND

Hydrocarbons are often produced from well bores by reciprocating downhole pumps that are driven from the surface by pumping units. A pumping unit is connected to its downhole pump by a rod string. Although several types of pumping units for reciprocating rod strings are known in the art, walking beam style pumps enjoy predominant use due to their simplicity and low maintenance requirements.

In most walking beam pumping units, the walking beam is pivotally supported atop a Samson post through a saddle bearing assembly. Typically, the Samson post includes a front leg and a rear leg that are secured to one another by a connection bracket below the saddle bearing assembly. The distal end of the front leg is secured to a base assembly of the pumping unit, often with a bolted connection. The distal end of the rear leg can be secured to the pedestal or to the base assembly of the pumping unit with large bolts. The Samson post carries a significant amount of weight and is exposed to lateral forces during the operation of the pumping unit. The base assembly also carries the weight of the sub base (or pedestal) and the gearbox, crank arms and other components supported by the pedestal.

In the past, the base assembly has been shipped to the well site and placed onto a concrete pad. The base assembly typically includes a series of interconnected steel beams that are anchored to the concrete pad with bolts. The Samson post and pedestal are the connected to the top of the base assembly. Although widely adopted, the use of an independent base assembly presents added shipping and installation costs. There is, therefore, a need for an improved support system for a walking beam pumping unit. It is to these and other deficiencies in the prior art that embodiments of the present invention are directed.

### SUMMARY OF THE INVENTION

In one aspect, a beam pumping unit includes an integrated base assembly that has a precast concrete pad and a support base partially embedded within the precast concrete pad. The beam pumping unit further comprises a Samson post connected to the support base and a walking beam supported by the Samson post.

In another aspect, a beam pumping unit includes an integrated base assembly that has a precast concrete pad and a support base. The support base includes one or more frame members. Each of the one or more frame members includes an exposed portion extending above the precast concrete pad and an embedded portion within the precast concrete pad. The beam pumping unit further includes a Samson post connected to the support base and a walking beam supported by the Samson post.

In another aspect, the embodiments include a method for making and assembling a beam pumping unit near a wellhead. The method begins with the step producing an integrated base assembly that has a support base within a concrete pad. Next, the method includes the step of placing the integrated base assembly near the wellhead. The method continues with the step of securing a Samson post to the integrated base assembly.

### BRIEF DESCRIPTION OF THE DRAWINGS

FIG. 1 is a side view of a conventional beam pumping unit with a first embodiment of the integrated base assembly.

FIG. 2 is a perspective view of a second embodiment of the integrated base assembly configured for a conventional beam pumping unit.

FIG. 3 is a perspective view of a linear drive beam pumping unit with an integrated base assembly.

FIG. 4 is a perspective view of an air balanced beam pumping unit with an integrated base assembly.

FIG. 5 is a side perspective, cutaway view of a post-tensioned pad.

FIG. 6 is a side perspective, cutaway view of a pre-tensioned pad.

FIG. 7 is a side perspective, cutaway view of a pad with rebar enforcement.

FIG. 8 is an end cross-sectional view of the integrated base assembly.

### WRITTEN DESCRIPTION

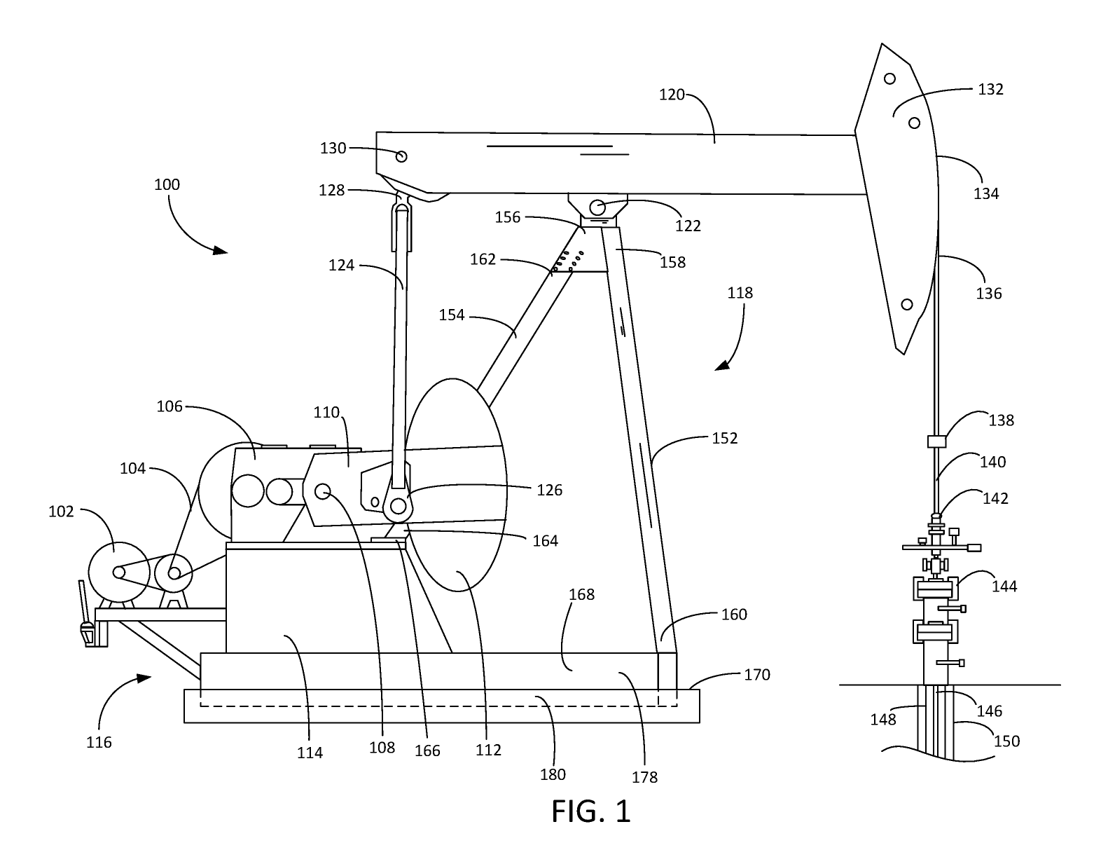

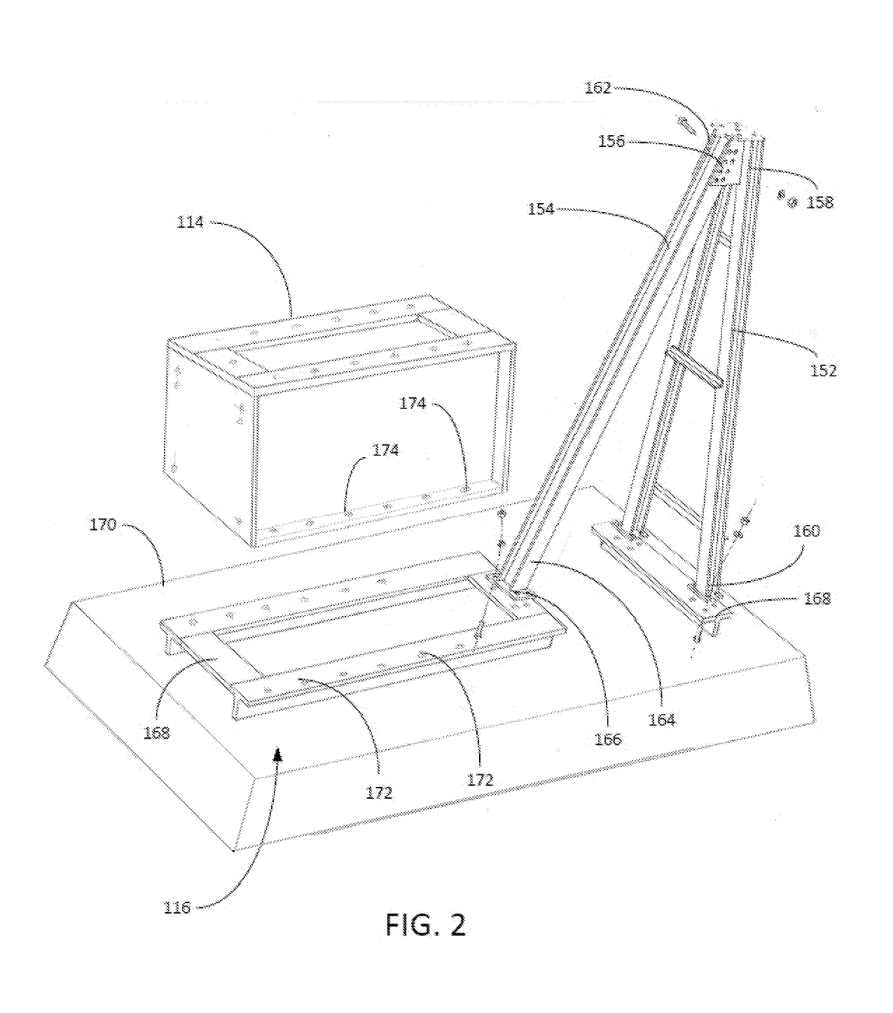

FIG. 1 shows a conventional beam pumping unit 100. The beam pumping unit 100 is driven by a prime mover 102, typically an electric motor or internal combustion engine. The rotational power output from the prime mover 102 is transmitted by a drive belt 104 to a gearbox 106. The gearbox 106 provides low-speed, high-torque rotation of a crankshaft 108. Each end of the crankshaft 108 (only one is visible in FIG. 1) carries a crank arm 110 and a counterbalance weight 112. The reducer gearbox 106 sits atop a sub base 114, which provides clearance for the crank arms 110 and counterbalance weights 112 to rotate. The gearbox sub base 114 is mounted atop an integrated base assembly 116. The integrated base assembly 116 also supports a Samson post 118. The top of the Samson post 118 acts as a fulcrum that pivotally supports a walking beam 120 via a saddle bearing assembly 122, commonly referred to as a center bearing assembly. FIG. 2 depicts a second embodiment of the integrated base assembly 116 configured for use with the conventional beam pumping unit 100.

Each crank arm 110 is pivotally connected to a pitman arm 124 by a crank pin bearing assembly 126. The two pitman arms 124 are connected to an equalizer bar 128, and the equalizer bar 128 is pivotally connected to the rear end of the walking beam 120 by an equalizer bearing assembly 130. A horse head 132 with an arcuate forward face 134 is mounted to the forward end of the walking beam 120. The face 134 of the horse head 132 interfaces with a flexible wire rope bridle 136. At its lower end, the bridle 136 terminates with a carrier bar 138, upon which a polished rod 140 is suspended.

The polished rod 140 extends through a packing gland or stuffing box 142 on a wellhead 144. A rod string 146 of sucker rods hangs from the polished rod 140 within a tubing string 148 located within the well casing 150. The rod string 146 is connected to the plunger of a subsurface pump (not illustrated). In a reciprocating cycle of the beam pumping unit 100, well fluids are lifted within the tubing string 148 during the upstroke of the rod string 146.

The Samson post 118 includes a front leg 152, a rear leg 154 and a connection bracket 156. In some embodiments, the connection bracket 156 is rigidly affixed to an upper end 158 of the front leg 152. The connection bracket 156 can be secured to the front leg 152 with a welded or bolted connection. A lower end 160 of the front leg 152 is rigidly secured to the base 116 at a predetermined and fixed angle. In this way, the front leg 152 and connection bracket 156 are held in a fixed geometric relationship with the integrated base assembly 116.

The rear leg 154 includes a proximal end 162 that is retained by the connection bracket 156. The rear leg 154 includes a distal end 164 that terminates in a rear foot 166. The rear foot 166 is attached to the distal end 164 at a fixed angle with a welded or bolted connection. The rear foot 166 is secured either to the sub base 114 (as shown in FIG. 1) or directly to the integrated base assembly 116 (as shown in FIG. 2). In both embodiments, the rear foot 166 is fixed in position with a bolted connection.

The integrated base assembly 116 includes a support base 168 and pad 170. The support base 168 includes one or more frame members constructed from steel or other high-strength metal that are at least partially embedded within the pad 170 during manufacture. In the embodiment depicted in FIG. 2, the support base 168 includes a number of fastener holes 172 that are sized and spaced to align with corresponding fastener holes 174 on the sub base 114 and Samson post 118. It will be appreciated that the Samson post 118 and sub base 114 are configured for a bolted connection to the support base 168, but that these components may also be welded to the support base 168 in certain embodiments. Unlike prior art approaches in which a large base structure is fixed to a concrete pad with anchor bolts at the well site, the components of the beam pumping system 100 can be bolted directly to exposed portions of the embedded support base 168 that ships with the pad 170.

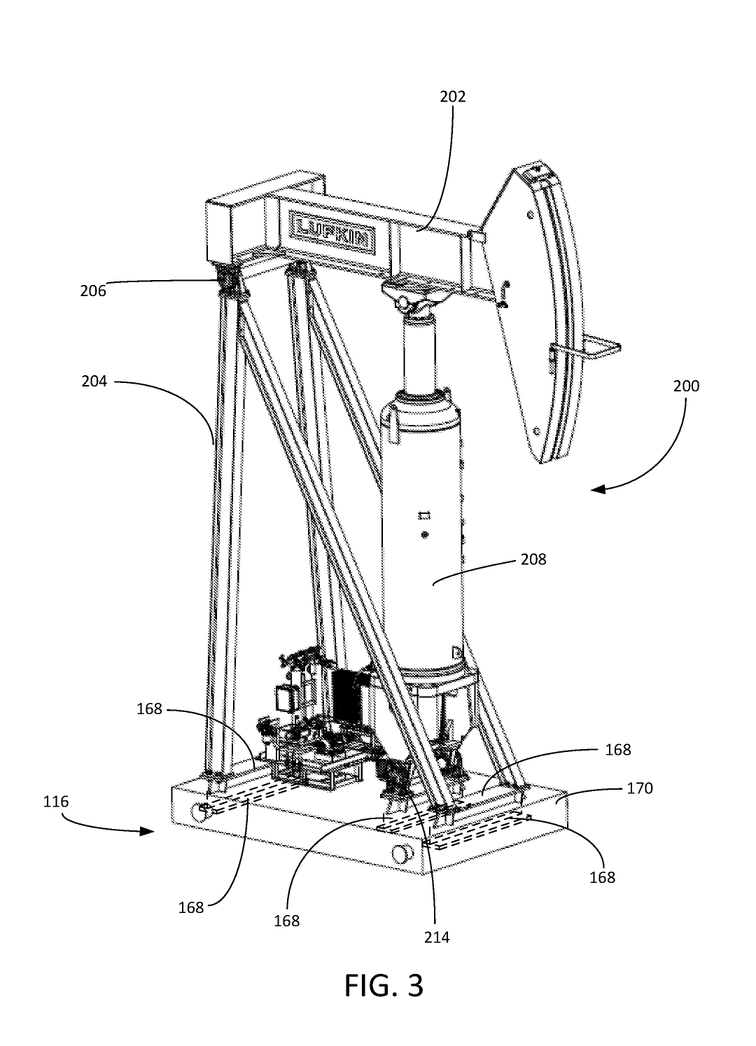

Turning to FIG. 3, shown therein is a perspective view of a linear drive beam pumping unit 200. The linear drive beam pumping unit 200 includes a walking beam 202 supported by a Samson post 204. The walking beam 202 rocks back and forth on a pivot bearing assembly 206. Unlike the conventional beam pumping unit 100, the linear drive beam pumping unit 200 includes a telescoping linear drive unit 208 that linearly reciprocates to raise and lower the walking beam 202.

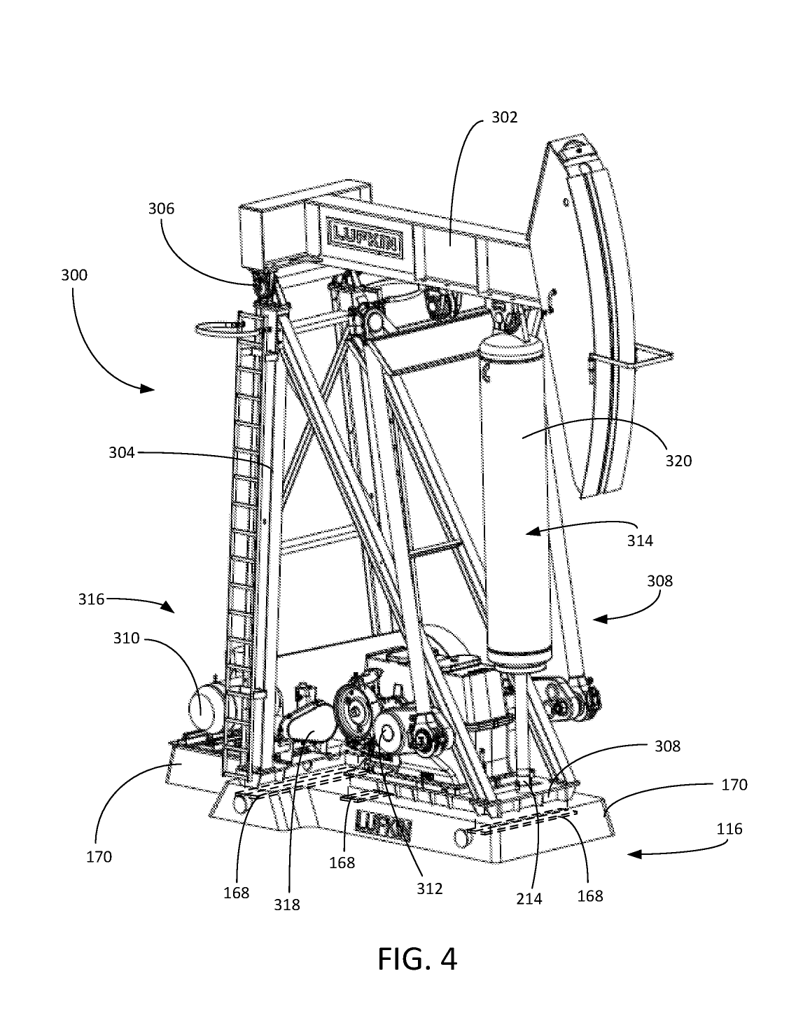

Turning to FIG. 4, shown therein is a perspective view of an air assist beam pumping unit 300. Like the linear drive beam pumping unit 200, the air assist beam pumping unit 300 includes a walking beam 302 supported by a Samson post 304. The walking beam 302 rocks back and forth on a pivot bearing assembly 306. The air assist beam pumping unit 300 includes a crank-linkage assembly 308 that lifts and lowers the walking beam 302 as a motor 310 rotates a crankshaft 312. In place of the conventional counterbalance weights, the air assist beam pumping unit 300 includes an air cylinder 314 to offsets a portion of the weight of the rod string 146 and other components within the well casing 150. Pressure within the air cylinder 314 is controlled with an air makeup system 316 that may include a compressor 318 and tank 320 (depicted as an internal component within the air cylinder 314).

The linear drive beam pumping unit 200 and air assist beam pumping unit 300 each include variations of the integral base assembly 116. The Samson posts 204, 304, the linear drive unit 208 and the air cylinder 314 are each mounted to the members of the support base 168, which are partially embedded within the pad 170. As best depicted in FIG. 3, the linear drive unit 208 is connected to the support base 168 with a pivoted connection 214 that permits the linear drive unit 208 to tilt as the walking beam 202 rocks back and forth about the pivot bearing 206. The air cylinder 314 is also connected to the support base 168 with a pivoted connection to permit a tilting movement during operation of the beam pumping unit 300. As used herein, the term “beam pumping unit” will refer to the category of beam pumping units that include but are not limited to Class I lever systems with crank counterbalance, Class III lever systems with crank counterbalance (“Mark II” designs), Class III lever systems with air counterbalance, Class I lever systems with phased-crank counterbalance, beam- balanced conventional systems (“Churchill” designs), the conventional beam pumping unit 100, the linear drive beam pumping unit 200, and the air assist beam pumping 300.

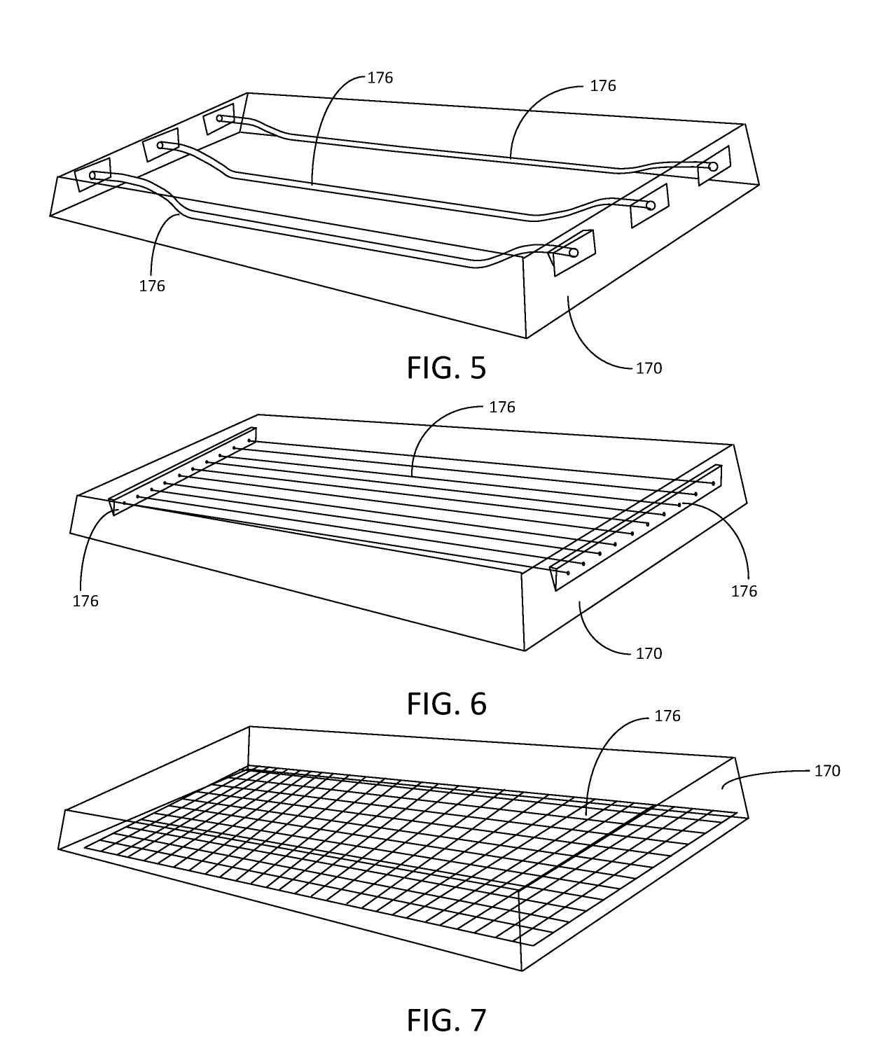

The pad 170 is a precast concrete pad that is designed and configured to distribute and transfer the weight and dynamic loading forces produced by the beam pumping units 100, 200, 300. As illustrated in FIGS. 5-7, the pad 170 may be constructed using post-tensioning (FIG. 5), pre-tensioning (FIG. 6), simple rebar reinforcement (FIG. 7), or a combination of these concrete casting and reinforcing methods. In each case, the concrete pad 170 may include a series of interconnected or separated structural reinforcements 176 that allow the pad to accommodate and withstand the cyclic tensile load forces that are produced by the beam pumping unit 100 during operation.

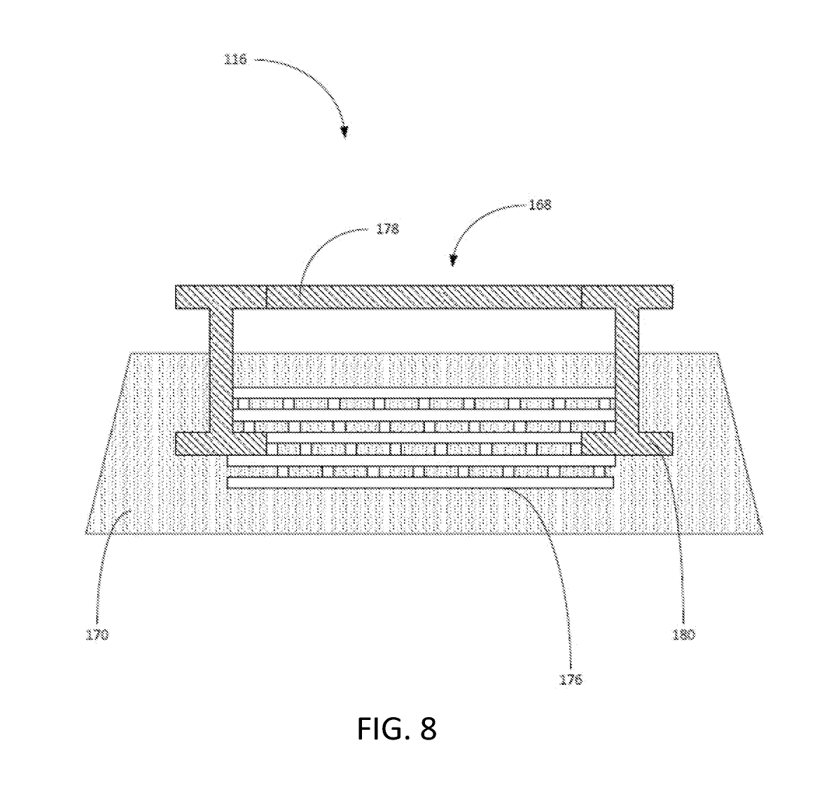

The support base 168 is embedded within the pad 170 and produced as an integrated, unitary component. As illustrated in FIGS. 1-4 and in the cross-sectional end-view of FIG. 8, the support base 168 includes an exposed portion 178 and an embedded portion 180. The exposed portion 178 extends out of the top of the pad 170 to facilitate connection with various components of the beam pumping units 100, 200, 300, including the sub base 114, the Samson posts 118, 204, 304, the linear drive unit 208 and the air cylinder 314. The embedded portion 180 of the support base 168 can be directly connected to the structural reinforcements 176. In the embodiment depicted in FIG. 8, the embedded portion 180 of the support base 168 is welded to the rebar matrix 176 that extends through the concrete pad 170.

During manufacture, the structural reinforcements 176 are assembled and placed into a concrete form (not shown). The support base 168 is then connected to the structural reinforcements 176 such that the exposed portion 178 of the support base 168 extends above the top of the concrete form. Next, an appropriate, high-strength concrete mixture is poured into the form to cover the embedded portion 180. Depending on the type of structural reinforcements 176 used and whether the concrete pad 170 is pre-tensioned or post-tensioned, additional steps may be required to complete the production of the integrated base assembly 116. When cured and fully and properly tensioned, the integrated base assembly 116 can be shipped to the well site and placed on a leveled landing surface. The various components of the beam pumping units 100, 200, 300 can then be secured to the exposed portion 180 of the support base 168. Thus, the integrated base assembly 116 presents an efficient, cost-effective solution for supporting the beam pumping units 100, 200, 300. The integrated base assembly 116 simplifies assembly of the beam pumping unit 100, 200, 300, improves the consistency of the concrete pad 170 and reduces the costs of shipping associated with the prior art method of delivering a separate support base 168 to the well site.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A beam pumping unit comprising:
an integrated base assembly; wherein the integrated base assembly comprises:
a precast concrete pad; and
a support base partially embedded within the precast concrete pad;
a Samson post connected to the support base; and
a walking beam supported by the Samson post.

2. The beam pumping unit of claim 1, wherein the precast concrete pad includes embedded structural reinforcements.

3. The beam pumping unit of claim 2, wherein the precast concrete pad is a post-tensioned concrete pad.

4. The beam pumping unit of claim 2, wherein the precast concrete pad is a pre-tensioned concrete pad.

5. The beam pumping unit of claim 2, wherein the precast concrete pad includes a matrix of rebar reinforcements.

6. The beam pumping unit of claim 2, wherein the support base includes an embedded portion and an exposed portion.

7. The beam pumping unit of claim 6, wherein the embedded portion is connected to the structural reinforcements within the precast concrete pad.

8. The beam pumping unit of claim 1, wherein the beam pumping unit is a conventional beam pumping unit that comprises:
a crankshaft;
crank arms connected to the crankshaft; and
a pitman arm connected between the crank arms and the walking beam.

9. The beam pumping unit of claim 8, further comprising counterbalance weights attached to the crank arms.

10. The beam pumping unit of claim 8, wherein the beam pumping unit is an air assist beam pumping unit that further comprises an air cylinder extending between the support base and the walking beam.

11. The beam pumping unit of claim 1, further comprising a linear drive unit connected between the support base and the walking beam.

12. A beam pumping unit comprising:
an integrated base assembly; wherein the integrated base assembly comprises:
a precast concrete pad; and
a support base that includes one or more frame members, wherein each of the one or more frame members comprises:
an exposed portion extending above the precast concrete pad; and
an embedded portion within the precast concrete pad;
a Samson post connected to the support base; and
a walking beam supported by the Samson post.

13. The beam pumping unit of claim 12, wherein the beam pumping unit is a conventional beam pumping unit that comprises:
a prime mover;
a crankshaft driven by the prime mover;
crank arms connected to the crankshaft; and
a pitman arm connected between the crank arms and the walking beam.

14. The beam pumping unit of claim 13, further comprising counterbalance weights attached to the crank arms.

15. The beam pumping unit of claim 13, wherein the beam pumping unit is an air assist beam pumping unit that further comprises an air cylinder extending between the support base and the walking beam.

16. The beam pumping unit of claim 1, further comprising a linear drive unit connected between the support base and the walking beam.

17. A method for making and assembling a beam pumping unit near a wellhead, the method comprising the steps of:
producing an integrated base assembly that has a support base within a concrete pad;
placing the integrated base assembly near the wellhead; and
securing a Samson post to the integrated base assembly.

18. The method of claim 17, wherein the step of producing an integrated base assembly further comprises:
placing structural reinforcements into a concrete form approximating the shape of the concrete pad;
connecting the support base to the structural reinforcements such that a first portion of the support base extends outside the concrete form and a second portion of the support base is positioned inside the concrete form; and
pouring concrete into the concrete form to form the concrete pad, wherein the step of pouring concrete comprises covering the structural reinforcements and the second portion of the support base.

19. The method of claim 18, further comprising a step of post-stressing the concrete pad after the step of pouring concrete.

20. The method of claim 18, wherein the step of placing structural reinforcements into a concrete form further comprises installing a matrix of rebar reinforcements into the concrete form.
